(19) United States
(12) Patent Application Publication
(10) Pub. No.: US 2023/0170544 A1
(43) Pub. Date: Jun. 1, 2023

(54) ELECTROCHEMICAL CELL HEAT SHUNT

(71) Applicant: Medtronic, Inc., Minneapolis, MN (US)

(72) Inventor: Joseph J. Viavattine, Vadnais Heights, MN (US)

(21) Appl. No.: 17/536,952

(22) Filed: Nov. 29, 2021

(51) Int. Cl. H01M 10/617; H01M 10/6554

(52) U.S. Cl. CPC H01M 10/617; H01M 10/6554; H01M 10/0525

(57) ABSTRACT

An electrochemical cell includes an anode, a cathode, one or more surfaces surrounding the anode and the cathode, and a heat shunt. The heat shunt covers at least a portion of the one or more surfaces and is configured to distribute heat generated by the electrochemical cell across the one or more surfaces.

### FIELD

The present disclosure relates to, among other things, electrochemical cells.

### TECHNICAL BACKGROUND

Lithium batteries may include one or more electrochemical cells. Each electrochemical cell includes an anode (e.g., a positive electrode), a cathode (e.g., a negative electrode), and an electrolyte provided within a case or housing. A separator made from a porous polymer or other suitable material may also be provided intermediate or between the anode and the cathode to prevent direct contact between the anode and the cathode. The anode includes a current collector having an active material provided thereon, and the cathode includes a current collector having an active material provided thereon.

Lithium electrochemical cells may be subject to lithium plating. Lithium plating is the formation of metallic lithium deposits on or around the anode of lithium electrochemical cells. Such plating may result in reduced capacity of the electrochemical cell or even failure of the electrochemical cell. Failure of the electrochemical cell may include internal shorting. Lithium plating may be exacerbated by non-uniform conditions in electrochemical cells that redirect current away from a direct path between the anode and the cathode.

### BRIEF SUMMARY

As described herein, a reduction in lithium plating may be achieved by decreasing a temperature gradient of individual electrochemical cells. Temperature gradients within or across surfaces of electrochemical cells may induce a voltage gradient within the electrochemical cell. Such voltage gradient may induce additional currents within the anode that result in dissolution of the anode in one location and lithium plating in another. Using a heat shunt, as described herein, to distribute heat across one or more surfaces of the electrochemical cell may reduce or prevent induction of such temperature gradient, thereby, reducing or preventing lithium plating caused by differences in voltage throughout the electrochemical cell. In addition, such heat shunts may reduce the amount of heat dissipated from the electrochemical cell, further preventing or reducing the temperature gradient across the electrochemical cell.

In general, in one aspect, the present disclosure describes an electrochemical cell comprising an anode, a cathode, one or more surfaces surrounding the anode and the cathode, and a heat shunt. The heat shunt covers at least a portion of the one or more surfaces and is configured to distribute heat generated by the electrochemical cell across the one or more surfaces.

In general, in another aspect, the present disclosure describes a system comprising an anode, a cathode, a housing, and one or more heat shunt sleeves. The housing comprises one or more surfaces and is configured to house the anode and the cathode. The one or more heat shunt sleeves are configured to receive the electrochemical cell such that the heat shunt sleeve covers at least a portion of the one or more surfaces. The one or more heat shunt sleeves further configured to distribute heat across the one or more surfaces of the housing.

In general, in another aspect, the present disclosure describes a system comprising a charging apparatus for charging one or more batteries and a battery operatively coupled to the charging apparatus. The battery comprises one or more electrochemical cells and a battery management system. The battery management system comprises one or more processors operably coupled to the one or more electrochemical cells. The battery management system is configured to determine an age of the battery, determine a charging voltage for charging the battery based on the determined age of the battery, wherein the charging voltage increases as the age of the battery increases, and cause the charger to charge the battery at the charging voltage for the duration of a charge cycle.

In general, in another aspect, the present disclosure describes a method comprising distributing heat across one or more surfaces of an electrochemical cell using a heat shunt.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 shows a schematic block diagram of an embodiment of an electrochemical cell;

FIG. 2 is an isometric view of the electrochemical cell of FIG. 1;

FIG. 3 is an isometric view of the electrochemical cell of FIG. 2 with a heat shunt;

FIG. 4 is an exploded isometric view of a heat shunt formed of a plurality of strips;

FIG. 5 is an isometric view of the electrochemical cell of FIG. 2 covered by the heat shunt of FIG. 4;

FIG. 6 is an isometric view of a heat shunt sleeve;

FIG. 7 is an isometric view of a system including the electrochemical cell of FIG. 2 and the heat shunt sleeve of FIG. 6;

FIG. 8 is an isometric view of another embodiment of an electrochemical cell;

FIG. 9 is an isometric view of yet another embodiment of an electrochemical cell; and

FIG. 10 is an isometric view of yet another embodiment of an electrochemical cell.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Reduction of lithium plating in lithium electrochemical cells can be achieved by using a heat shunt to distribute heat across one or more surfaces of individual electrochemical cells. Distribution of heat across the one or more surfaces of an electrochemical cell may reduce temperature gradients within or on the surface of the electrochemical cell. Such reduction in temperature gradients may also reduce voltage gradients (e.g., voltage gradients induced by temperature gradients in the electrochemical cell) that direct current away from a direct path between an anode and a cathode of the electrochemical cell. Because such currents may cause or exacerbate lithium plating, reduction of temperature gradients by distributing heat across one or more surfaces of the electrochemical cell using the heat shunt may ultimately result in reduced lithium plating within the electrochemical cell. Accordingly, electrochemical cells or systems that include a heat shunt as described herein may advantageously be less susceptible to degradation and potential failures caused by lithium plating.

Furthermore, heat shunts as described herein may resist heat dissipation from electrochemical cells in addition to being configured to distribute heat across one or more surfaces of the electrochemical cells. In other words, the rate of heat loss of an electrochemical cell may be greater without a heat shunt than with a heat shunt. For example, the heat shunt may be configured to conduct heat along a plane or surface of the heat shunt while also being resistant to heat transfer through such plane or surface. Resisting heat dissipation or heat loss from the electrochemical cell may further reduce the temperature gradient of the electrochemical cell.

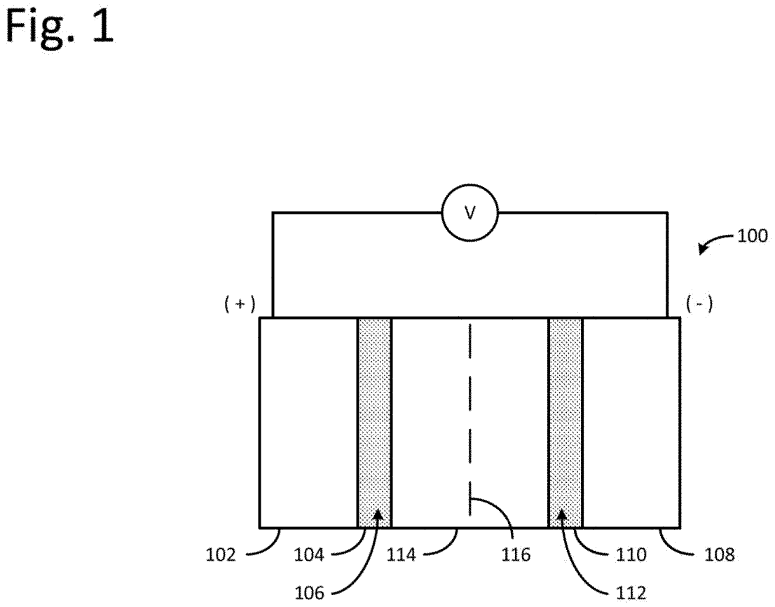

FIG. 1 shows a schematic representation of an electrochemical cell 100. The electrochemical cell 100 includes an anode 102 that includes a positive current collector 104 and a positive active material 106, a cathode 108 that includes a negative current collector 110 and a negative active material 112, an electrolyte material 114, and a separator 116 (e.g., a polymeric microporous separator, indicated by the dashed line) provided intermediate or between the anode 102 and the cathode 108. The electrodes 102, 108 may be provided as relatively flat or planar plates or may be wrapped or wound in a spiral or other configuration (e.g., an oval configuration). The electrode may also be provided in a folded configuration.

The electrochemical cell 100 may include any suitable chemistry. The chemistry of the electrochemical cell 100 may include, for example, lithium-metal, lithium-ion, lithium polymer, or other chemistries that may be subject to plating issues. In at least one embodiment, the electrochemical cell 100 includes a lithium-metal battery cell. The electrochemical cell 100 may be a primary cell or a secondary cell. In other words, the electrochemical cell 100 may or may not be rechargeable.

During charging and discharging of the electrochemical cell 100, lithium ions move between the anode 102 and the cathode 108. For example, when the electrochemical cell 100 is discharged, lithium ions flow from the cathode 108 to the anode 102. In contrast, when the electrochemical cell 100 is charged, lithium ions flow from the anode 102 to the cathode 108.

As the electrochemical cell 100 charges or discharges, some of the electrical or chemical energy may be converted to heat energy due to internal resistances of the electrochemical cell 100. The heat generated by such internal resistances may not easily spread or conduct to other portions of the electrochemical cell 100 without a heat shunt. Accordingly, during charging or discharging a significant temperature gradient may be induced in the electrochemical cell 100 that ultimately exacerbates lithium plating in the electrochemical cell. In contrast, the use of a heat shunt to distribute heat across one or more surfaces of the electrochemical cell 100 may allow heat to more easily spread throughout the electrochemical cell 100, reduce the temperature gradient throughout the electrochemical cell 100, and ultimately reduce lithium plating in the electrochemical cell 100.

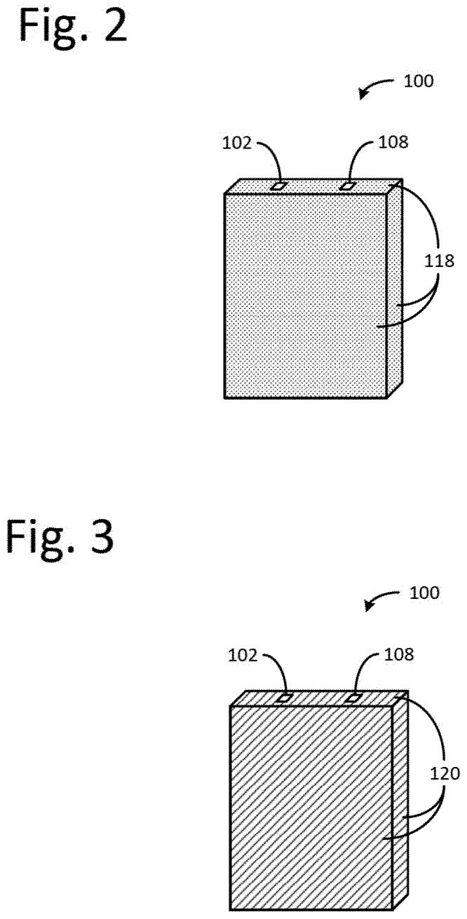

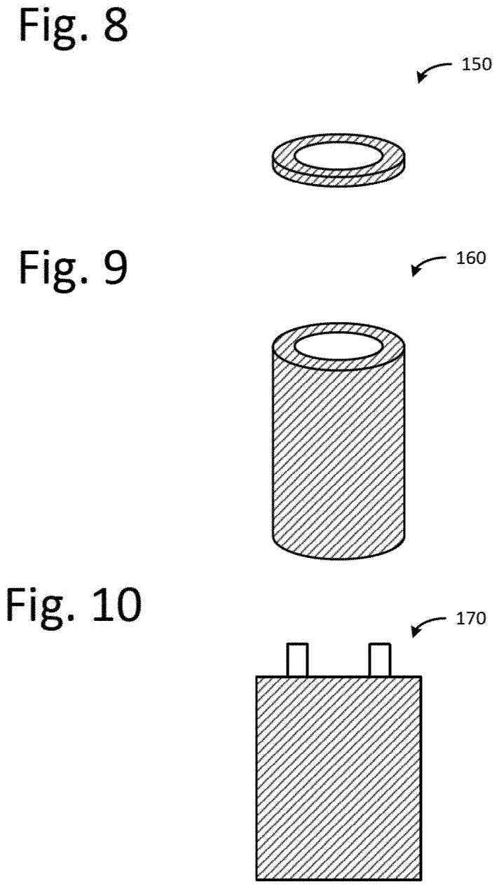

FIGS. 2 and 3 show an isometric view of the electrochemical cell 100. In FIG. 2 the electrochemical cell 100 is shown without a heat shunt. In FIG. 3 the electrochemical cell 100 is shown covered by a heat shunt 120. Although the electrochemical cell 100 is depicted as a prismatic electrochemical cell, the electrochemical cell 100 can take on any suitable shape (e.g., electrochemical cells 150, 160, 170 of FIGS. 8-10).

The electrochemical cell 100 includes one or more surfaces 118 surrounding at least a portion of each of the anode 102 and the cathode 108. Another portion of each of the anode 102 and the cathode 108 are exposed through the one or more surfaces 118 to allow the electrochemical cell 100 to provide electrical energy to an electrical device or circuit. The one or more surfaces 118 may also surround the positive current collector 104, the negative current collector 110, the electrolyte material 114, and the separator 116.

The one or more surfaces 118 may be part of a housing or may be part of packaging. A housing for the electrochemical cell may include any suitable resilient material or materials. Resilient (e.g., resistant to puncture and corrosion and chemically stable) material or materials may be configured to protect the internal components (e.g., anode 140, cathode 142, positive current collector, negative current collector, electrolyte material, separator, etc.) of the electrochemical cell 100. Such resilient materials may include, for example, nickel, steel, titanium, aluminum, or other resilient materials. Packaging may include any suitable packaging material or materials for holding internal components of the electrochemical cell 100 together in a predefined shape. Such packaging materials may include, plastic, ceramics, etc. Additionally, when the one or more surfaces 118 are part of the packaging, a housing may include the heat shunt 120.

The electrochemical cell 100 includes a heat shunt 120 as shown in FIG. 3. The heat shunt 120 covers at least a portion of the one or more surfaces 118 of the electrochemical cell. The heat shunt 120 is configured to distribute heat generated by the electrochemical cell 100 across the one or more surfaces 118. Additionally, the heat shunt 120 may resist dissipation of heat from the electrochemical cell 100. In other words, the heat shunt 120 may be configured to spread heat across the electrochemical cell and reduce the transfer of heat from the electrochemical cell to an exterior environment.

The heat shunt 120 may include any suitable material or materials to facilitate distribution of heat across one or more surfaces of the electrochemical cell 100 and resistance to dissipation of heat from the electrochemical cell 100. Such materials may include sheets or strips of, for example, graphene, molybdenum dichalcogenides, tungsten dichalcogenides, black phosphorus, copper, copper laminated with polyimide, aluminum, laminated aluminum, graphene on polymer carriers, graphite, diamond, or other materials with similar properties. The heat shunt 120 may include a film coated in any of the listed materials to facilitate distribution of heat across one or more surfaces of the electrochemical cell 100. In at least one embodiment, the heat shunt 120 includes graphene. Additionally, heat shunts 120 that include or are made from graphene or other materials that may be formed as sheets that are efficient thermal conductors may allow the electrochemical cells 100 to be smaller compared to devices that may employ other additional insulative materials in an attempt to thermally isolate the electrochemical cell 100.

The materials of the heat shunt 120 may conduct heat more efficiently across surfaces of the heat shunt 120 than through the heat shunt 120. In other words, the ability of the heat shunt 120 to transfer heat (e.g., thermal conductivity) in-plane (e.g., along a surface) exceeds the ability of the heat shunt to transfer heat cross-plane (e.g., through the sheet or layer). The heat shunt 120 may have an in-plane thermal conductivity of about 2000 Watts per millikelvin (W/mK) to about 4000 W/mK). The heat shunt 120 may have a cross-plane thermal conductivity of about 5 W/mK to about 10 W/mK. A ratio of the in-plane thermal conductivity to the cross-plane thermal conductivity of the heat shunt 120 may be about 200:1 to about 800:1.

The electrochemical cell 100 may further include an adhesive (not shown) configured to adhere the heat shunt 120 to the one or more surfaces 118. For example, an adhesive layer may be disposed on inner surfaces of the heat shunt 120 or on the one or more surfaces 118. The adhesive may be a double side adhesive film, glue, epoxy, or other suitable adhesive. The adhesive may also provide additional resistance to heat dissipation.

The heat shunt 120 may be formed from a single sheet. Such sheet may be wrapped around the one or more surfaces 118. Portions of such sheet may be folded or cut to fit various dimensions of the electrochemical cell 100.

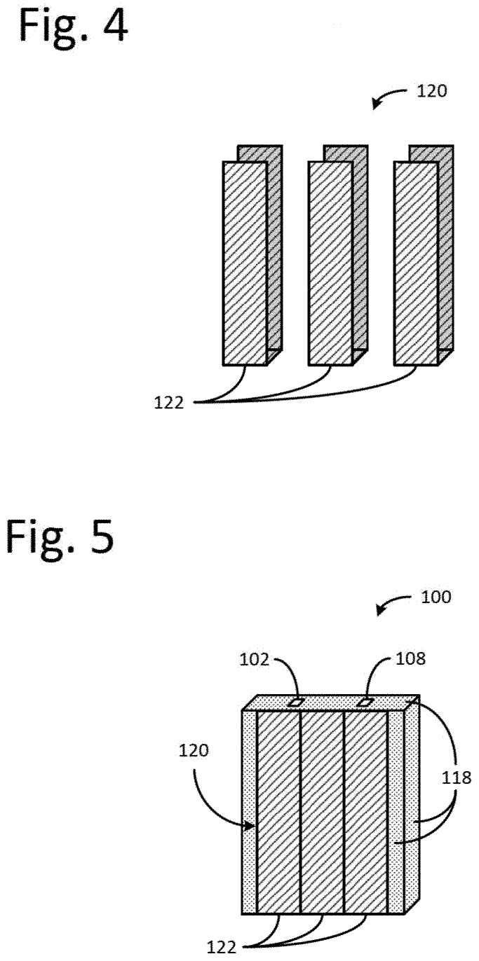

Additionally, or alternatively, the heat shunt 120 may include a plurality of strips 122 as shown in FIGS. 4 and 5. FIG. 4 shows an exploded isometric view of the heat shunt 120 formed from the plurality of strips 122. FIG. 5 shows the electrochemical cell 100 with the heat shunt 120 formed from the plurality of strips 122. The plurality of strips 122 may take on any suitable size or shape. Such shapes may include, for example, cylinders, rectangles, tubes, rings, circles, parabolas, arcs, etc. Furthermore, the plurality of strips 122 may be bent, curved, or folded to conform to the shape of the electrochemical cell 100. Additionally, such bending, curving or folding may allow a single strip of the plurality of strips 122 to cover more than one side or surface of the electrochemical cell 100. Accordingly, the heat shunt 120 can distribute heat between multiple surfaces of the electrochemical cell 100. The plurality of strips 122 may be arranged about the one or more surfaces 118 directly adjacent to one another as shown in FIG. 5. Such arrangement may allow heat to be distributed between the plurality of strips 122. However, the plurality of strips 122 may also be arranged with gaps in between two or more of the plurality of strips 122 to direct heat distribution along desired paths and prevent heat distribution along other paths.

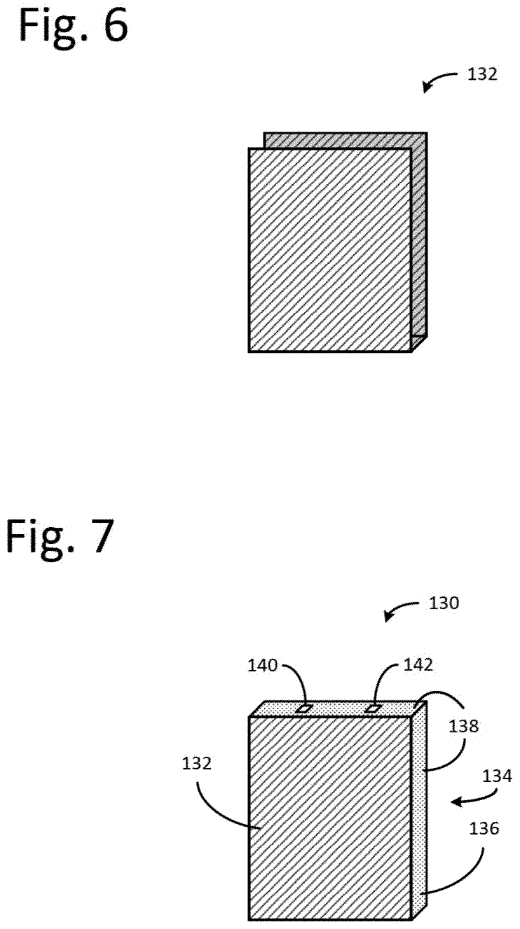

The heat shunt 120 may also be a heat shunt sleeve 132 as shown in FIGS. 6 and 7. FIG. 6 shows an isometric view of the heat shunt sleeve 132. FIG. 7 shows an isometric view of a system 130 including the heat shunt sleeve 132 and an electrochemical cell 134.

The electrochemical cell 134 may include any suitable chemistry and take on any suitable shape as described herein with regard to electrochemical cell 100. The electrochemical cell 134 includes an anode 140, a cathode 142, and a housing 136. The housing 136 includes the one or more surfaces 138. The housing 136 may be configured to house at least a portion of the anode 140 and the cathode 142. The housing 136 may include any suitable resilient (e.g., resistant to puncture and corrosion and chemically stable) material or materials configured to protect the internal components (e.g., anode 140, cathode 142, positive current collector, negative current collector, electrolyte material, separator, etc.). Such resilient materials may include, for example, nickel, steel, titanium, aluminum, or other resilient materials.

The heat shunt sleeve 132 may be configured to receive the electrochemical cell 134 such that the heat shunt sleeve 132 covers at least a portion of one or more surfaces 138 of the housing 136 of the electrochemical cell 134. Additionally, the heat shunt sleeve 132 may be configured to distribute heat across the one or more surfaces 138 of the housing 136 of the electrochemical cell 134. The heat shunt sleeve 132 may include a plurality of strips covering that at least a portion of the one or more surfaces 138. Alternatively, the heat shunt sleeve 132 may include a single sheet.

The system 130 may also include an adhesive (not shown) configured to adhere the heat shunt sleeve 132 to the one or more surfaces 138 of the housing 136. The adhesive may be applied to the one or more surfaces 138 or an inner surface of the heat shunt sleeve 132. The adhesive may include a double-sided adhesive film or other suitable adhesive.

FIGS. 8-10 show various shapes or forms that electrochemical cells described herein can take on. FIG. 8 shows a button electrochemical cell 150, FIG. 9 shows a cylindrical electrochemical cell 160, and FIG. 10 shows a pouch electrochemical cell 170. Each of the cells 150, 160, 170 includes an anode, a cathode, and a heat shunt covering one or more surfaces.

The invention is defined in the claims. However, below there is provided a non-exhaustive list of non-limiting examples. Any one or more of the features of these examples may be combined with any one or more features of another example, embodiment, or aspect described herein.

Example Ex1: An electrochemical cell comprising: an anode; a cathode; one or more surfaces surrounding at least a portion of each of the anode and the cathode; and a heat shunt covering at least a portion of the one or more surfaces and configured to distribute heat generated by the electrochemical cell across the one or more surfaces.

Example Ex2: The electrochemical cell of example Ex1, wherein the heat shunt comprises graphene.

Example Ex3: The electrochemical cell of example Ex1, wherein the heat shunt comprises a plurality of strips covering the at least a portion of the one or more surfaces of the electrochemical cell.

Example Ex4: The electrochemical cell of example Ex1, wherein the heat shunt comprises a sheet covering the at least a portion of the one or more surfaces of the electrochemical cell.

Example Ex5: The electrochemical cell of example Ex1, wherein the heat shunt is further configured to resist dissipation of heat from the electrochemical cell.

Example Ex6: The electrochemical cell of example Ex1, further comprising a housing configured to house the anode, the cathode, and the one or more surfaces; wherein the housing comprises the heat shunt.

Example Ex7: The electrochemical cell of example Ex1, further comprising an adhesive configured to adhere the heat shunt to the one or more surfaces.

Example Ex8: The electrochemical cell of example Ex1, wherein the electrochemical cell comprises a lithium metal battery cell.

Example Ex9: A system comprising: an electrochemical cell comprising: an anode; a cathode; and a housing comprising one or more surfaces and configured to house at least a portion of the anode and the cathode; and one or more heat shunt sleeves configured to: receive the electrochemical cell such that the heat shunt sleeve covers at least a portion of the one or more surfaces; and distribute heat across the one or more surfaces of the housing.

Example Ex10: The system of example Ex9, wherein the one or more heat shunt sleeves comprise graphene.

Example Ex11: The system of example Ex9, wherein the one or more heat shunt sleeves comprise a plurality of strips covering the at least a portion of the one or more surfaces of the housing.

Example Ex12: The system of example Ex9, wherein the one or more heat shunt sleeves comprise a sheet covering the at least a portion of the one or more surfaces of the housing.

Example Ex13: The system of example Ex9, wherein the one or more heat shunt sleeves is further configured to resist dissipation of heat from the electrochemical cell.

Example Ex14: The system of example Ex9, wherein the electrochemical cell comprises a lithium metal battery cell.

Example Ex15: The system of example Ex9, further comprising an adhesive configured to adhere the heat shunt sleeve to the one or more surfaces of the housing.

Example Ex16: A method comprising distributing heat across one or more surfaces of an electrochemical cell using a heat shunt.

Example Ex17: The method of example Ex16, wherein the heat shunt comprises graphene.

Example Ex18: The method of example Ex16, wherein the heat shunt comprises a plurality of strips covering a at least a portion of the one or more surfaces of the electrochemical cell.

Example Ex19: The method of example Ex16, wherein the heat shunt comprises a sheet covering a at least a portion of the one or more surfaces of the electrochemical cell.

Example Ex20: The method of example Ex16, wherein distributing the heat across the one or more surfaces of the electrochemical cell reduces a temperature gradient of the one or more surfaces.

Example Ex21: The method of example Ex16, further comprising resisting dissipation of heat from the electrochemical cell using the heat shunt.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. An electrochemical cell comprising:
an anode;
a cathode;
one or more surfaces surrounding at least a portion of each of the anode and the cathode; and
a heat shunt covering at least a portion of the one or more surfaces and configured to distribute heat generated by the electrochemical cell across the one or more surfaces.

2. The electrochemical cell of claim 1, wherein the heat shunt comprises graphene.

3. The electrochemical cell of claim 1, wherein the heat shunt comprises a plurality of strips covering the at least a portion of the one or more surfaces of the electrochemical cell.

4. The electrochemical cell of claim 1, wherein the heat shunt comprises a sheet covering the at least a portion of the one or more surfaces of the electrochemical cell.

5. The electrochemical cell of claim 1, wherein the heat shunt is further configured to resist dissipation of heat from the electrochemical cell.

6. The electrochemical cell of claim 1, further comprising a housing configured to house the anode, the cathode, and the one or more surfaces;
wherein the housing comprises the heat shunt.

7. The electrochemical cell of claim 1, further comprising an adhesive configured to adhere the heat shunt to the one or more surfaces.

8. The electrochemical cell of claim 1, wherein the electrochemical cell comprises a lithium metal battery cell.

9. A system comprising:
an electrochemical cell comprising:
an anode;
a cathode; and
a housing comprising one or more surfaces and configured to house at least a portion of the anode and the cathode; and
one or more heat shunt sleeves configured to:
receive the electrochemical cell such that the heat shunt sleeve covers at least a portion of the one or more surfaces; and
distribute heat across the one or more surfaces of the housing.

10. The system of claim 9, wherein the one or more heat shunt sleeves comprise graphene.

11. The system of claim 9, wherein the one or more heat shunt sleeves comprise a plurality of strips covering the at least a portion of the one or more surfaces of the housing.

12. The system of claim 9, wherein the one or more heat shunt sleeves comprise a sheet covering the at least a portion of the one or more surfaces of the housing.

13. The system of claim 9, wherein the one or more heat shunt sleeves is further configured to resist dissipation of heat from the electrochemical cell.

14. The system of claim 9, wherein the electrochemical cell comprises a lithium metal battery cell.

15. The system of claim 9, further comprising an adhesive configured to adhere the heat shunt sleeve to the one or more surfaces of the housing.

16. A method comprising distributing heat across one or more surfaces of an electrochemical cell using a heat shunt.

17. The method of claim 16, wherein the heat shunt comprises graphene.

18. The method of claim 16, wherein the heat shunt comprises a plurality of strips covering a at least a portion of the one or more surfaces of the electrochemical cell.

19. The method of claim 16, wherein the heat shunt comprises a sheet covering a at least a portion of the one or more surfaces of the electrochemical cell.

20. The method of claim 16, wherein distributing the heat across the one or more surfaces of the electrochemical cell reduces a temperature gradient of the one or more surfaces.

21. The method of claim 16, further comprising resisting dissipation of heat from the electrochemical cell using the heat shunt.
